(19) United States
(12) Patent Application Publication
(10) Pub. No.: US 2026/0104490 A1
(43) Pub. Date: Apr. 16, 2026

(54) METHOD OF REMOVING BLOOMING IN SURROUNDING OBJECT CLUSTERS ACQUIRED BY LIDAR SENSOR

(71) Applicant: SUM, INC., Siheung-si (KR)

(72) Inventors: Young Jin HYUN, Seongnam-si (KR); Dae Hyuck PARK, Daejeon (KR); Ji Hyoung KIM, Ansan-si (KR); Jeong Goo SEO, Suwon-si (KR); Hyun Sung LEE, Seongnam-si (KR); Jong Cherl PARK, Siheung-si (KR); Jong Seo LEE, Siheung-si (KR)

(21) Appl. No.: 19/357,706

(22) Filed: Oct. 14, 2025

(30) Foreign Application Priority Data
Oct. 16, 2024 (KR) 10-2024-0141580

(51) Int. Cl. G01S 7/48; G01S 17/894

(52) U.S. Cl. CPC G01S 7/4808; G01S 7/4802; G01S 17/894

(57) ABSTRACT

Proposed is a method of removing blooming in a surrounding object cluster acquired by a LiDAR sensor. The method includes (A) setting, by an object recognition system, a first threshold for an average of reflection intensity of points for determining a region of interest containing a surrounding object having high reflectivity, (B) setting a second threshold for determining the blooming, (C) receiving point-cloud data from the LiDAR sensor, (D) segmenting the region of interest on the basis of the point-cloud data, (E) removing points corresponding to the ground from the segmented region of interest, (F) performing point-cloud clustering for the region of interest, (G) calculating an average of the reflection intensity of the points, (H) comparing the calculated average with the first threshold, (I) determining that the region of interest contains the surrounding object having the high reflectivity, and (J) determining the blooming and removing the same.

### CROSS REFERENCE TO RELATED APPLICATION

The present application claims priority to Korean Patent Application No. 10-2024-0141580, filed on Oct. 16, 2024, the entire contents of which are incorporated herein for all purposes by this reference.

### BACKGROUND

### Technical Field

The present disclosure relates to a method of removing blooming in a surrounding object cluster acquired by a LiDAR sensor.

### Description of the Related Art

Unless otherwise indicated in the present specification, the matters described in this section are not a prior art with respect to the claims of the present application, and inclusion in this section shall not be deemed to constitute an admission of prior art.

A Light Detection And Ranging (LiDAR) is a device that generates a precise representation of the surroundings by emitting a laser pulse and detecting the light that reflects off surrounding target objects and returns, such that a distance to an object is measured. By measuring the time (t) taken for a laser beam to return at the speed (c), the distance to the target object can be calculated as ct/2. A set of distance data to the target object in a three-dimensional (3D) space is referred to as point-cloud data and an image of the surrounding object in the three-dimensional space can be generated on the basis of the point-cloud data.

When there is an object having high reflectivity among the surrounding objects, the energy of the reflected light is high, and the light scattered by dust or water vapor in the air is detected by the LiDAR sensor. This phenomenon can cause point data to be generated even for a space where no surrounding objects actually exist. This is referred to as “blooming.” Blooming poses a problem of distorting the spatial image generated by the LiDAR sensor when the LiDAR sensor acquires point-cloud data and generates the spatial image around the LiDAR sensor.

### RELATED ART DOCUMENTS

### Patent Document

(Patent Document 1) Korean Patent Application Publication No. 10-2021-0090384 (Jul. 20, 2021)

### SUMMARY

In order to solve the aforementioned problem, the present disclosure aims to provide a method of segmenting a region of interest in point-cloud data received from a LiDAR sensor, determining a region of interest containing an object having high reflectivity, and removing blooming in the region of interest containing the object having the high reflectivity.

A method of removing blooming according to an exemplary embodiment of the present disclosure employs an object recognition system containing a LiDAR sensor, and includes (A) setting, by the object recognition system, a first threshold for an average of reflection intensity of points as a criterion for determining a region of interest containing a surrounding object having high reflectivity, (B) setting, by the object recognition system, a second threshold for the reflection intensity of the points as a criterion for determining the blooming, (C) receiving, by the object recognition system, point-cloud data from the LiDAR sensor, (D) segmenting, by the object recognition system, the region of interest on the basis of the point-cloud data, (E) removing points corresponding to the ground from the segmented region of interest, (F) performing, by the object recognition system, point-cloud clustering for the region of interest from which the points corresponding to the ground are removed, (G) calculating, by the object recognition system, an average of the reflection intensity of the points in the region of interest after the point-cloud clustering, (H) comparing, by the object recognition system, the calculated average of the reflection intensity of the points in the region of interest with the first threshold, (I) determining, by the object recognition system, that the region of interest contains the surrounding object having the high reflectivity when the average of the reflection intensity of the points in the region of interest is greater than the first threshold, and (J) determining, by the object recognition system, points in the region of interest, whose reflection intensity is less than the second threshold, as the blooming and removing the same.

As an exemplary embodiment, the method of removing blooming according to the present disclosure may further include (K) setting, by the object recognition system, a third threshold for a standard deviation of the reflection intensity of the points as the criterion for determining the region of interest containing the surrounding object having the high reflectivity, (L) calculating, by the object recognition system, the standard deviation of the reflection intensity of the points in the segmented region of interest, (M) comparing, by the object recognition system, the calculated standard deviation of the reflection intensity of the points in the region of interest with the third threshold, and (N) determining, by the object recognition system, that the region of interest contains the surrounding object having the high reflectivity when the standard deviation of the reflection intensity of the points in the region of interest is less than the third threshold.

The method of removing blooming according to an exemplary embodiment of the present disclosure may segment a region of interest in point-cloud data received from a LiDAR sensor, determine whether to contain an object having high reflectivity on the basis of an average of refection intensity of points in the region of interest, and then remove the blooming, thereby optimizing process resources required for blooming removal, reducing the time required for blooming removal, and generating a spatial image for surrounding objects without distortion through blooming removal.

The method of removing blooming according to an exemplary embodiment of the present disclosure can more accurately determine whether to contain an object having high reflectivity by determining whether an object having high reflectivity is included on the basis of a standard deviation of reflection intensity of points in the region of interest.

The effects of the present disclosure are not limited to the effects described above, and should be understood to include all effects that can be inferred from the detailed description of the present disclosure or the composition of the disclosure described in the claims.

### BRIEF DESCRIPTION OF THE DRAWINGS

FIG. 1 is a view illustrating a concept of reflection intensity of a LiDAR sensor in a method of removing blooming according to an exemplary embodiment of the present disclosure.

FIG. 2 is a view illustrating a spatial image including blooming generated on the basis of point-cloud data acquired by a LiDAR sensor.

FIG. 3 is a flowchart illustrating a method of removing blooming according to an exemplary embodiment of the present disclosure.

FIG. 4 is a view illustrating a region of interest in a method of removing blooming according to an exemplary embodiment of the present disclosure.

FIG. 5 is a view illustrating a spatial image after blooming removal in a method of removing blooming according to an exemplary embodiment of the present disclosure.

FIG. 6 is a flowchart as an exemplary embodiment in a method of removing blooming according to an exemplary embodiment of the present disclosure.

### DETAILED DESCRIPTION OF THE DISCLOSURE

Hereinafter, an exemplary embodiment disclosed in the present specification will be described in detail with reference to the accompanying drawings, but the same or similar components will be assigned the same reference numbers regardless of the drawing codes, and redundant descriptions thereof will be omitted. The terms such as “module” and “unit” used for components in the following description may be assigned or used interchangeably only for the convenience of writing the specification, and do not have distinct meanings or roles in themselves. In addition, in describing exemplary embodiments disclosed in the present specification, the detailed description thereof will be omitted when it is determined that a detailed description of the related known technology may obscure the gist of the exemplary embodiment disclosed in the present specification. In addition, the accompanying drawings may be provided merely to facilitate understanding the exemplary embodiment disclosed in the present specification, and the technical ideas disclosed in the present specification may not be limited by the accompanying drawings, and should be understood to include all changes, equivalents or substitutes included in the spirit and technical scope of the present disclosure.

Terms including ordinal numbers, such as first and second, may be used to describe various components, but the above components may not be limited by the above terms. The terms may be used only for the purpose of distinguishing one component from another component.

In this application, the terms “include” or “have” may be intended to specify the presence of features, numbers, steps, operations, components, parts, or combinations thereof described in the specification, and should be understood not to preclude the presence or addition of one or more other features, numbers, steps, operations, components, parts, or combinations thereof.

In the present specification, the term “unit” may include a unit implemented by hardware, a unit implemented by software, and a unit implemented by both. In addition, one unit may be implemented by using two or more hardware, or two or more units may be implemented by one hardware.

Hereinafter, a method of removing blooming 30 in a surrounding object image acquired by a LiDAR sensor 10 according to an exemplary embodiment of the present disclosure will be described in detail with reference to the drawings.

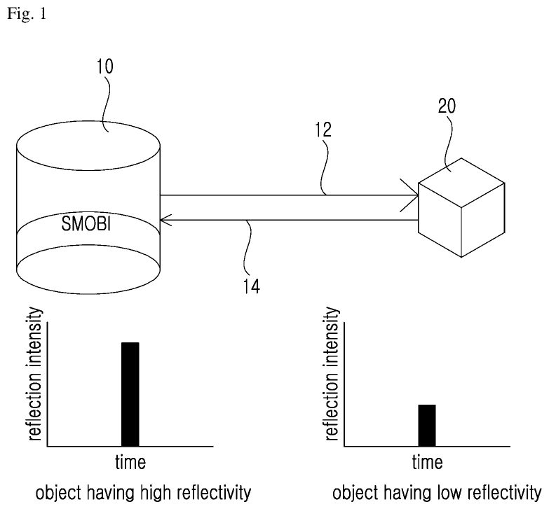

FIG. 1 is a view illustrating a concept of reflection intensity of a LiDAR sensor 10 in a method of removing blooming 30 according to an exemplary embodiment of the present disclosure. The LiDAR sensor 10 may typically employ a multi-channel rotating LiDAR sensor. The rotating LiDAR sensor may measure space while a LiDAR module composed of a laser and a detector housed within the LiDAR sensor 10 rotates at regular intervals. The term “multi-channel” may mean that multiple LiDAR modules measure the space while maintaining a constant angle in the vertical direction. An object recognition system (not shown) may receive cloud-point data from the LiDAR sensor 10 and, based thereon, may generate a surrounding spatial image (also referred to as a “cluster”). The object recognition system may be a computing device including at least one memory and at least one CPU. The object recognition system may be configured to receive cloud-point data from the LiDAR sensor 10 by a wired or wireless communication method.

As shown in FIG. 1, the LiDAR sensor 10 may include a light-emitting unit for projecting the laser light 12 toward the surrounding space, and a detection unit for receiving the reflected light 14 reflected when the laser light 12 is reflected by the surface of the surrounding object 20. The LiDAR sensor 10 may measure the time at which the reflected light 14 is detected and the reflection intensity of the reflected light 14 and may transmit the aforementioned time and reflection intensity to the object recognition system. The detected time may be a physical quantity related to the distance from the LiDAR sensor 10 to the surrounding object 20, and the reflection intensity may be a physical quantity related to the reflectivity of the surface of the surrounding object 20. Referring to FIG. 1, when the reflectivity of the surface of the surrounding object 20 is high, the reflection intensity of the reflected light 14 may be measured to be high, and when the reflectivity of the surface of the surrounding object 20 is low, the reflection intensity of the reflected light 14 may be measured to be low. The object recognition system may generate the surrounding spatial image on the basis of the received time and reflection intensity.

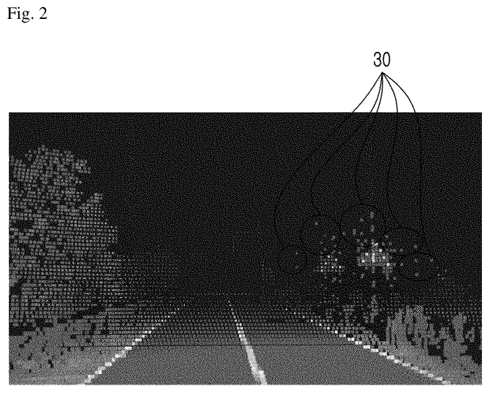

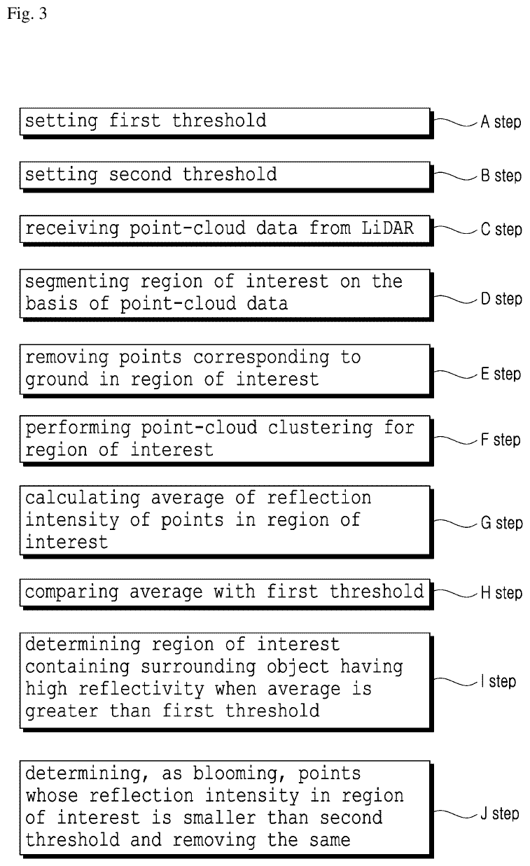

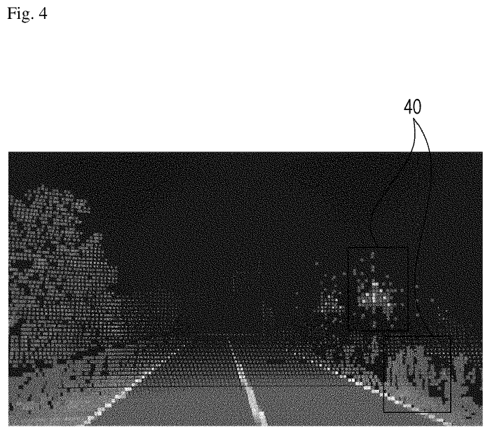

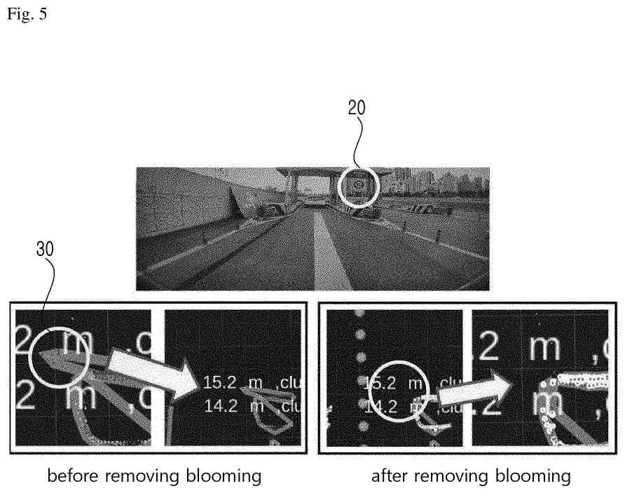

FIG. 2 is a view illustrating a spatial image including blooming 30 generated on the basis of point-cloud data acquired by a LiDAR sensor 10, FIG. 3 is a flowchart illustrating a method of removing blooming 30 according to an exemplary embodiment of the present disclosure, FIG. 4 is a view illustrating a region of interest 40 in a method of removing blooming 30 according to an exemplary embodiment of the present disclosure, and FIG. 5 is a view illustrating a spatial image after blooming 30 removal in a method of removing blooming 30 according to an exemplary embodiment of the present disclosure.

As shown in FIG. 2, the spatial image generated on the basis of point-cloud data acquired by the LIDAR sensor 10 may include blooming 30. The blooming 30 may be generally points where the LIDAR sensor 10 detects the light scattered and reflected by the surrounding object 20 having the high reflectivity. The triangular surrounding object 20 in FIG. 2 may be a signboard. The signboard may have the high reflectivity, causing blooming 30 to occur around it.

The example of FIG. 3 is a flowchart illustrating a method of removing the blooming 30 in the region of interest 40 after determining whether the region of interest 40 includes the surrounding object 20 having the high reflectivity in the region of interest 40. The method of removing the blooming 30 according to an exemplary embodiment of the present disclosure may employ the object recognition system containing the LiDAR sensor 10, and may include (A) setting, by the object recognition system, a first threshold for an average of reflection intensity of points as a criterion for determining a region of interest 40 containing a surrounding object 20 having high reflectivity, (B) setting, by the object recognition system, a second threshold for the reflection intensity of the points as a criterion for determining the blooming 30, (C) receiving, by the object recognition system, point-cloud data from the LiDAR sensor 10, (D) segmenting, by the object recognition system, the region of interest 40 on the basis of the point-cloud data, (E) removing points corresponding to the ground from the segmented region of interest 40, (F) performing, by the object recognition system, point-cloud clustering for the region of interest 40 from which the points corresponding to the ground are removed, (G) calculating, by the object recognition system, an average of the reflection intensity of the points in the region of interest 40 after the point-cloud clustering, (H) comparing, by the object recognition system, the calculated average of the reflection intensity of the points in the region of interest 40 with the first threshold, (I) determining, by the object recognition system, that the region of interest 40 contains the surrounding object 20 having the high reflectivity when the average of the reflection intensity of the points in the region of interest 40 is greater than the first threshold, and (J) determining, by the object recognition system, points in the region of interest 40, whose reflection intensity is less than the second threshold, as the blooming 30 and removing the same.

In the step (A), the first threshold may be a threshold as the criterion for determining the region of interest 40 containing the surrounding object 20 having the high reflectivity. As an example, the object recognition system may classify the reflection intensity of the points received from the LiDAR sensor 10 into 255 levels, and may generate a spatial image by representing the points with a color corresponding to each level from 0 to 255 level, thereby enabling the surrounding object 20 to be confirmed with the naked eye. As an example, the object recognition system may classify the reflection intensity of the points received from the LiDAR sensor 10 into 2800 levels, and may generate the spatial image by representing the points with the color corresponding to each level from 0 to 2800 level, thereby enabling the surrounding object 20 to be confirmed with the naked eye. Herein, the levels of the reflection intensity may be only an example and may not be limited thereto. In the case of the object recognition system that classifies the reflection intensity of the points received from the LiDAR sensor 10 into 255 levels, the first threshold may preferably be 128, which is 50% of the highest reflection intensity of 255, and more preferably 192, which is 75% of the highest reflection intensity of 255.

In the step (B), the second threshold may be a threshold as the criterion for determining the blooming 30. The blooming 30 points may be points generated by the light scattered from surrounding objects 20 having the high reflectivity and generally have a very low reflection intensity. Since the average of the reflection intensity of the points in the region of interest 40 containing the surrounding object 20 having the high reflectivity is generally high, the reflection intensity of the blooming 30 points generated by the scattered light may be generally significantly lower than the aforementioned average. Accordingly, the object recognition system may preferably set, as the second threshold, 50% of the average reflection intensity of the points in the region of interest 40 among the reflection intensities of the points in the region of interest 40, more preferably 40% of the average reflection intensity of the points in the region of interest 40 among the reflection intensities of the points in the region of interest 40, and still more preferably, 30% of the average reflection intensity of the points in the region of interest 40 among the reflection intensities of the points in the region of interest 40.

In the step (C), the object recognition system may receive the point-cloud data from the LiDAR sensor 10. Herein, the point-cloud data may refer to a set of data for the points, where the time of the reflected light 14 measured by the LiDAR sensor 10 and the reflection intensity of the reflected light 14 are included. The object recognition system may generate the spatial image of the surroundings on the basis of the point-cloud data received from the LiDAR sensor 10. In this case, the generated spatial image may include the blooming 30 as shown in FIG. 2.

In the step (D), the object recognition system may segment the region of interest 40 on the basis of the point-cloud data. Referring to FIG. 4, the region of interest 40 may be a unit mask including the surrounding object 20. The region of interest 40 may include a single surrounding object 20. As an example, referring to FIG. 4, the single region of interest 40 may include a signboard, which is the surrounding object 20 having the high reflectivity, and another region of interest 40 may include a tree, which is the surrounding object 20 having the low reflectivity.

In order to segment the region of interest 40 containing the surrounding object 20, the object recognition system may further include an artificial intelligence module that extracts feature points by training with the image of the surrounding objects 20 on the basis of the deep learning and then extracts the surrounding object 20 in the surrounding spatial image generated by the object recognition system.

In the step (E), the object recognition system may remove the points corresponding to the ground from the segmented region of interest 40. Since the ground is not the surrounding object 20 corresponding to an obstacle to vehicle travel, removing the corresponding points may reduce the CPU and memory capacity required for the operation of removing the blooming 30. Thereafter, in the step (F), the object recognition system may perform point-cloud clustering for the region of interest 40 in which the points corresponding to the ground are removed. Herein, the point-cloud clustering may refer to generating the spatial image for the region of interest containing the surrounding object 20 by clustering the points corresponding to the surrounding object 20.

In the step (G), the object recognition system may calculate an average of the reflection intensity of the points in the region of interest 40 after the point-cloud clustering. As an example, the average of the reflection intensity of the points in the region of interest 40 containing the signboard, which is the surrounding object 20 having the high reflectivity, may be high, and the average of the reflection intensity of the points in the region of interest 40 containing the tree, which is the surrounding object 20 having the low reflectivity, may be low.

In the step (H), the object recognition system may compare the calculated average of the reflection intensity of the points in the region of interest 40 with the first threshold, and in the step (I), the object recognition system may determine that the object of interest 40 contains the surrounding object 20 having the high reflectivity when the average of the reflection intensity of the points in the region of interest 40 is greater than the first threshold. As an example, the average reflection intensity of the points in the region of interest 40 containing the signboard, which is the surrounding object 20 having the high reflectivity, may be higher than the first threshold, and the average reflection intensity of the points in the region of interest 40 containing the tree, which is the surrounding object 20 having the low reflectivity, may be lower than the first threshold.

In the step (J), when it is determined that the region of interest 40 contains the surrounding object 20 having the high reflectivity, the object recognition system may determine and remove the points smaller than the second threshold among the reflection intensities of the points in the region of interest 40 as the blooming 30. FIG. 5 shows an example of the surrounding spatial image generated by the object recognition system after removing the blooming 30 points by the method of removing the blooming 30 of the present disclosure.

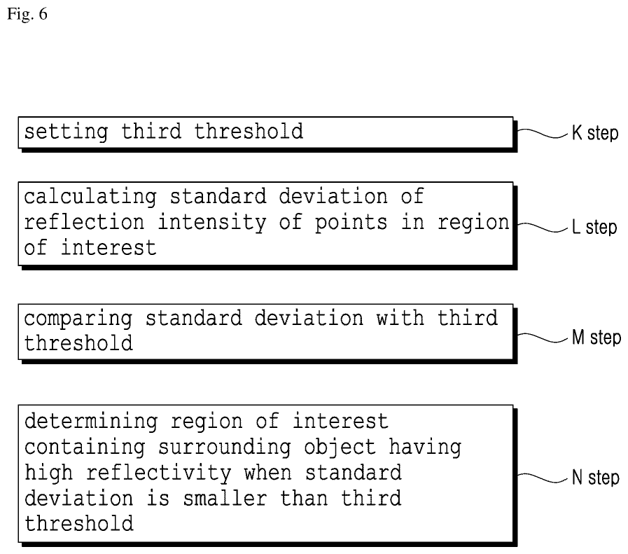

FIG. 6 is a flowchart as an exemplary embodiment in a method of removing blooming 30 according to an exemplary embodiment of the present disclosure.

As an exemplary embodiment, the method of removing the blooming 30 according to the exemplary embodiment of the present disclosure may further include (K) setting, by the object recognition system, a third threshold for a standard deviation of the reflection intensity of the points as the criterion for determining the region of interest 40 containing the surrounding object 20 having the high reflectivity, (L) calculating, by the object recognition system, the standard deviation of the reflection intensity of the points in the segmented region of interest 40, (M) comparing, by the object recognition system, the calculated standard deviation of the reflection intensity of the points in the region of interest 40 with the third threshold, and (N) determining, by the object recognition system, that the region of interest 40 contains the surrounding object 20 having the high reflectivity when the standard deviation of the reflection intensity of the points in the region of interest 40 is less than the third threshold.

In the step (K), the third threshold may be a threshold different from the aforementioned first threshold, which is the criterion for determining the region of interest 40 containing the surrounding object 20 having the high reflectivity. Since the reflection intensity of the points in the region of interest 40 containing the surrounding object 20 having the high reflectivity is high and uniformly distributed, the standard deviation of the reflection intensity of the points in the region of interest 40 may be generally small. The third threshold may be determined by experimentally measuring the standard deviation of the reflection intensity of the points in the region of interest 40 containing the surrounding object 20 having the high reflectivity.

In the step (L), the object recognition system may calculate the standard deviation of the reflection intensity of the points in the segmented region of interest 40. As an example, the standard deviation of the reflection intensity of the points in the region of interest 40 containing the signboard, which is the surrounding object 20 having the high reflectivity, may be low since there are many points having the high reflection intensity, and the standard deviation of the reflection intensity of the points in the region of interest 40 containing the tree, which is the surrounding object 20 having the low reflectivity, may be high.

In the step (M), the object recognition system may compare the calculated standard deviation of the reflection intensity of the points in the region of interest 40 with the third threshold, and in the step (N), the object recognition system may determine that the region of interest 40 contains the surrounding object 20 having the high reflectivity when the standard deviation of the reflection intensity of the points in the region of interest 40 is less than the third threshold. For this reason, the surrounding object system may verify once again whether the region of interest 40 contains the surrounding object 20 having the high reflectivity.

The disclosed content is merely illustrative, and may be varied and implemented in diverse ways by those skilled in the art without departing from the gist of the claims claimed in the patent such that the scope of protection of the disclosed content is not limited to the specific exemplary embodiment described above.

This invention was supported by the Korean National R&D Program.
Unique Project Number: 2370000322
Project Number: RS-2024-00441262
Ministry: Ministry of Culture, Sports and Tourism
Funding Agency: Korea Creative Content Agency
R&D Program Name: Cultural Technology R&D
Research Project Title: Development of New Technology Convergence Content-based
UX Service Technology for In-Vehicle Occupant Cultural Content Consumption in Mobility
Contribution Rate: 1/1
Performing Organization: Korea Photonics Technology Institute
Research Period: 2024. 07. 01.˜2026. 12. 31.

What is claimed is:

1. A method of removing blooming by using an object recognition system containing a LiDAR sensor, the method comprising:
(A) setting, by the object recognition system, a first threshold for an average of reflection intensity of points as a criterion for determining a region of interest containing a surrounding object having high reflectivity;
(B) setting, by the object recognition system, a second threshold for the reflection intensity of the points as a criterion for determining blooming;
(C) receiving, by the object recognition system, point-cloud data from the LiDAR sensor;
(D) segmenting, by the object recognition system, the region of interest on the basis of the point-cloud data;
(E) removing points corresponding to the ground from the segmented region of interest;
(F) performing, by the object recognition system, point-cloud clustering for the region of interest from which the points corresponding to the ground are removed;
(G) calculating, by the object recognition system, an average of the reflection intensity of the points in the region of interest after the point-cloud clustering;
(H) comparing, by the object recognition system, the calculated average of the reflection intensity of the points in the region of interest with the first threshold;
(I) determining, by the object recognition system, that the region of interest contains the surrounding object having the high reflectivity when the average of the reflection intensity of the points in the region of interest is greater than the first threshold; and
(J) determining, by the object recognition system, points in the region of interest, whose reflection intensity is less than the second threshold, as the blooming and removing the same.

2. The method of claim 1, further comprising:
(K) setting, by the object recognition system, a third threshold for a standard deviation of the reflection intensity of the points as the criterion for determining the region of interest containing the surrounding object having the high reflectivity;
(L) calculating, by the object recognition system, the standard deviation of the reflection intensity of the points in the segmented region of interest;
(M) comparing, by the object recognition system, the calculated standard deviation of the reflection intensity of the points in the region of interest with the third threshold; and
(N) determining, by the object recognition system, that the region of interest contains the surrounding object having the high reflectivity when the standard deviation of the reflection intensity of the points in the region of interest is less than the third threshold.
